(19) United States
(12) Patent Application Publication
(10) Pub. No.: US 2004/0228132 A1
(43) Pub. Date: Nov. 18, 2004

(54) Structure of foldable lampshade

(76) Inventor: Yen-Ping Sun, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/436,986

(22) Filed: May 14, 2003

(51) Int. Cl. F21V 1/06

(52) U.S. Cl. 362/352

(57) ABSTRACT

The improved structure of foldable lampshade foldable rods between a connecting portion and an upper annular ring, each foldable rod is composed of a first and a second rod section pivotally connected with each other and respectively fixed on the upper annular ring and the connecting portion, when the first and second rod sections are pulled straight or folded, the connecting portion is fixed by bracing or is folded too; the structure is characterized by: each foldable rod is provided on the first rod section thereof with a holder in the form of a slide sleeve for the purpose of firmly holding the stacking portion of the first rod section and a second rod section when the first and the second rod sections are pulled straight, the holder restrains the first and the second rod sections from folding in a contrary direction to assure the structural firmness of the connecting portion and the lampshade and to avoid the danger of tilting of the lampshade.

### BACKGROUND OF THE INVENTION

1. Field of the Invention

The present invention is related to an improved structure of foldable lampshade, and especially to an improvement on the structure of a connecting portion of a foldable lampshade to be assembled on a lamp set; with the improvement, the connecting portion can not only have the feature of ability of folding, but also have a firm connecting structure for connecting with the lampshade, thereby, tilting of the lampshade can be avoided.

2. Description of the Prior Art

As shown in FIG. 1 which shows a structure of foldable lampshade the inventor of the present invention developed before, the main body of the lampshade has an upper and a lower annular ring 20, 30 respectively on the top and the bottom of a soft shading member 10, and a plurality of brackets 40 are provided between the upper and the lower annular rings 20, 30 to brace the soft shading member 10, the brackets 40 brace the lampshade completely to form a truncated conical shape of the lampshade. The lower annular ring 30 can be an annular member formed from two semicircles, a pivot joint is provided between the two semicircles to make the two closable to lap with each other; so that when the lampshade is dismantled, the brackets 40 can be detached to allow collapsing and stacking of the upper and the lower annular rings 20, 30 one on the other, the lower annular ring 30 can further be folded; thereby, the latitude and the width that the entire lampshade occupies can be largely reduced to in turn reduce the amount of material for packing and the cost of transporting.

More over, a common foldable lampshade is provided at the center of the upper annular ring 20 with a connecting portion 2l for the convenience of assembling the lampshade with a lamp set, the connecting portion 21 is provided on the periphery thereof with a plurality of radiant connecting rods 22 connecting between the connecting portion 21 and the upper annular ring 20 to get better strength. The lamp set in mating with the lampshade renders the height of the connecting portion of the lampshade different by the diversity among the designed structures of the racks on various lamp sets for the lampshade. Hence there has been a measure changing the connecting rods for fixedly connecting the connecting portion on the upper annular ring into foldable rods; the foldable rods are formed by pivotal connecting of a plurality of first rod sections and second rod sections respectively fixedly connecting to the upper annular ring and the connecting portion. The first and second rod sections are pulled straight to brace the connecting portion to get a fixed shape; an when in collapsing the lampshade, the first and second rod sections of the foldable rods are collapsed to shorten the foldable rods, this meets the object of designing of reducing the volume of packing for the foldable lampshade.

However, conventional foldable rods are deficient in providing a structure to effectively fix the first and second rod sections although they have the function of folding for collapsing, thereby, in practical using of the lampshade, the first and second rod sections may be folded in contrary directions because of inadvertent impact to make the lampshade tilt and touch the lamp bulb to thereby induce the danger of burning of the soft shading member.

### SUMMARY OF THE INVENTION

The improved structure of foldable lampshade of the present invention comprises a soft shading member, an upper and a lower annular ring connected with the soft shading member, a plurality of brackets provided between the upper and the lower annular rings to brace the soft shading member, and a connecting portion connected with the upper annular ring for assembling the lampshade with a lamp set. Wherein a plurality of foldable rods each is provided on a first rod section thereof with a holder in the form of a slide sleeve for the purpose of firmly holding the stacking portion of the first rod section and a second rod section when the first and the second rod sections are pulled straight, the holder restrains the first and the second rod sections from folding in a contrary direction to assure the structural firmness of the connecting portion and the lampshade and to avoid the danger of tilting of the lampshade.

The present invention will be apparent after reading the detailed description of the preferred embodiment thereof in reference to the accompanying drawings.

### BRIEF DESCRIPTION OF THE DRAWINGS

FIG. 1 is a schematic perspective view showing the structure of a conventional foldable lampshade that the applicant of the present invention developed before;

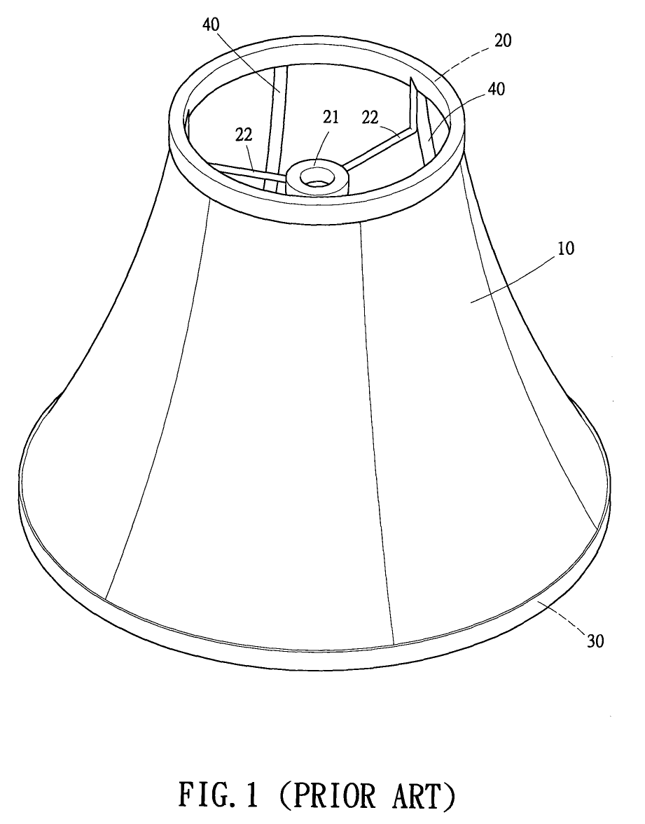

FIG. 2 is a partially exploded perspective view showing the structure of the entire lampshade of the present invention;

FIG. 3 is a schematic perspective view showing assembling of a plurality of brackets with an upper and a lower annular ring of the present invention;

FIG. 4 is a perspective view showing the structure including two sets of foldable rods each having a first and a second rod section of the present invention in a folded state;

FIG. 5 is a schematic perspective view showing the first and second rod sections of two foldable rods of the present invention both in a pulled-straight state;

FIG. 6 is a schematic perspective view showing the first and second rod sections are clamped firm by two holders of the present invention;

FIG. 7 is a sectional schematic view showing the first and second rod sections are clamped firm by the two holders of the present invention;

FIG. 8 is a sectional schematic view showing the first and second rod sections are clamped firm by the two holders of another embodiment of the present invention.

### DETAILED DESCRIPTION OF THE PREFERRED EMBODIMENT

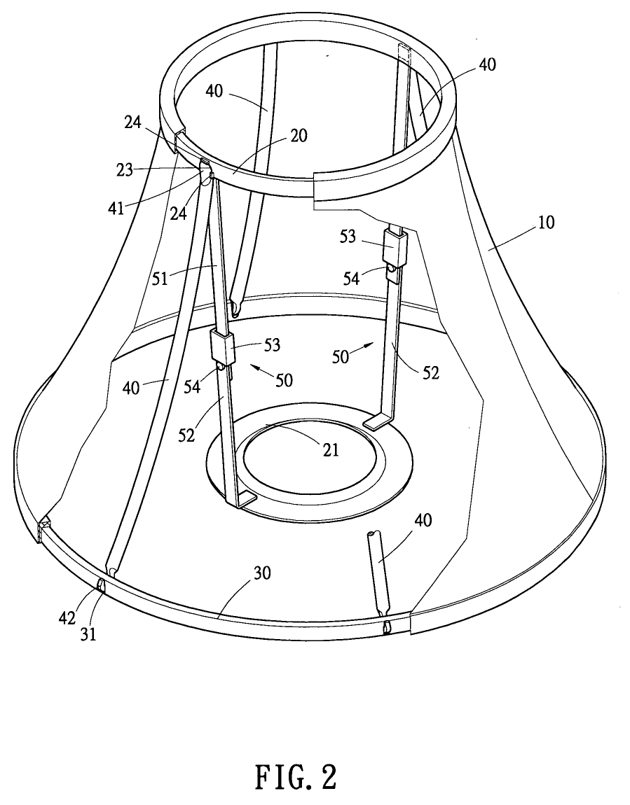

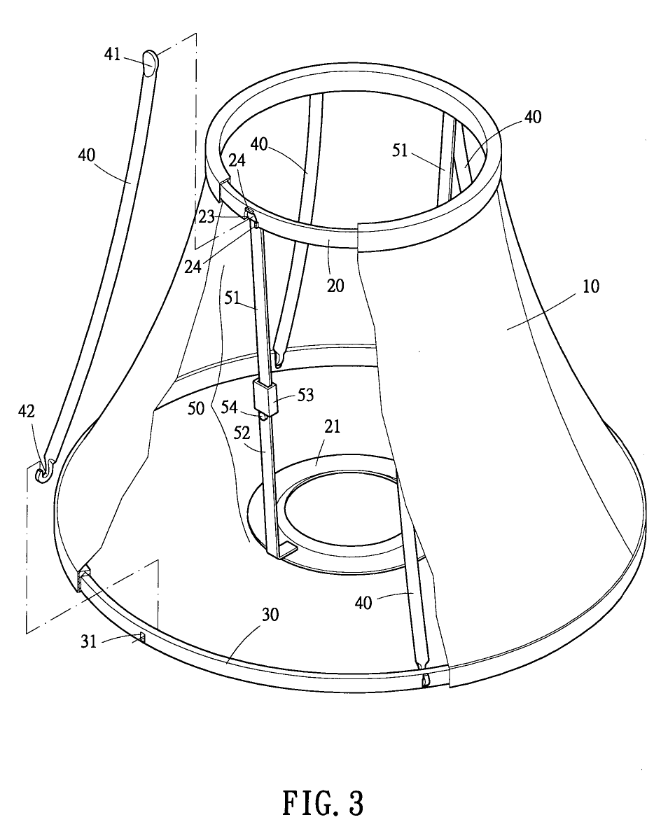

On the improved structure of foldable lampshade of the present invention, as shown in FIGS. 2 and 3, the main body of the lampshade likely includes on the top and the bottom of a soft shading member 10 an upper annular ring 20 and a lower annular ring 30, and a plurality of brackets 40 provided between the upper and lower annular rings 20, 30 to brace the soft shading member 10; the brackets 40 brace the whole lampshade to form the shading member 10 a truncated conical surface; a connecting portion 21 in the form of a slipping-over member is connected with the upper annular ring 20 for assembling of the lampshade 10 with a lamp set.

Wherein the brackets 40 each is in the form of a single rod; the upper and the lower annular rings 20, 30 are provided on the peripheries thereof at the positions in corresponding to those for connecting the ends of the brackets 40 with recesses 23 and holes 31. The brackets 40 are further provided each on the ends thereof respectively with a butt portion 41 and a hook portion 42 able to engage respectively with the recesses 23 and the holes 31. When the brackets 40 are mounted on the upper and the lower annular rings 20, 30, the upper and the lower annular rings 20, 30 can be firmly connected with the brackets 40 by engagement of the butt portions 41 and the hook portions 42 with the recesses 23 and the holes 31 of the upper and the lower annular rings 20, 30 respectively. And the soft shading member 10 can be surely braced by elastic function of the brackets 40.

Each recess 23 has stop means 24 respectively on the top edge and a lateral side thereof. The top stop means 24 restrain the butt portions 41 of the brackets 40 from sliding off the recesses 23, while all the lateral stop means 24 are provided respectively on the like one of every two lateral sides. Thereby, when a bracket 40 is assembled with the corresponding upper and the lower annular rings 20, 30, the hook portion 42 of the bracket 40 is extended into the hole 31 of the lower annular ring 30, and the butt portion 41 of the bracket 40 is extended into the recess 23 of the upper ring 20 and engage with an edge of the recess 23, then the butt portion 41 of the bracket 40 is pushed toward the recess 23 to render the butt portion 41 to surely engage in the recess 23, thereby, the lampshade can be fast assembled.

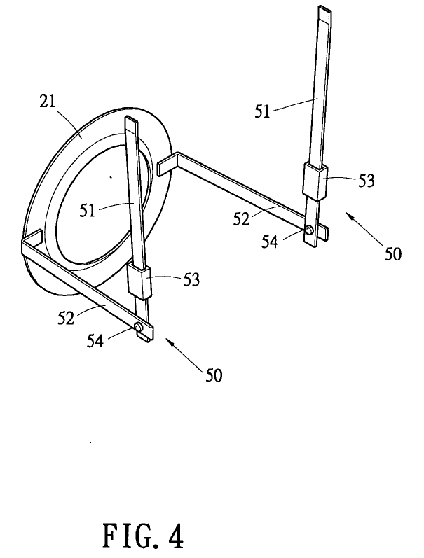

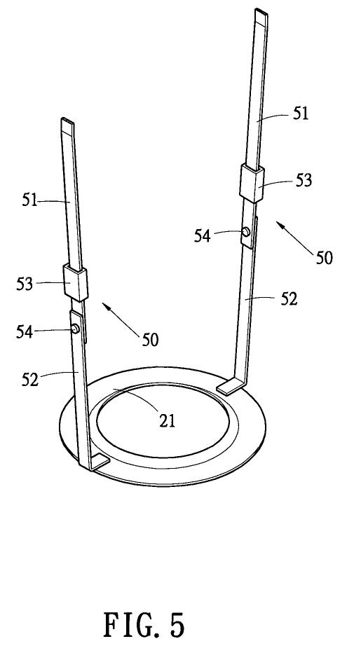

And more, as shown in FIGS. 2 and 4, the connecting portion 21 of the lampshade is connected with the upper ring 20 by means of two foldable rods 50; each foldable rod 50 is composed of a first rod section and a second rod section 51, 52 pivotally connected with each other and respectively fixed on the upper ring 20 and the connecting portion 21. Thereby, when the first and the second rod sections 51, 52 are pulled straight (as shown in FIG. 5) or folded (as shown in FIG. 4), the connecting portion 21 is fixed by bracing or is folded too.

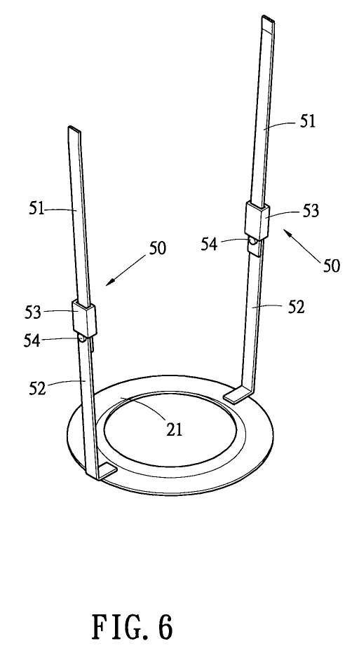

Particularly, the first rod section 51 of a foldable rod 50 is provided with a holder 53 in the form of a slide sleeve, as shown in FIGS. 5 and 6, when the first and the second rod sections 51, 52 are pulled straight, the holder 53 can be tightly slipped over the mutual stacking area of the first and the second rod sections 51, 52, the holder 53 can then restrain the first and the second rod sections 51, 52 from folding in a contrary direction to assure the structural firmness of the connecting portion 21 and the lampshade such as is shown in FIG. 2, and to avoid the danger of tilting of the lampshade.

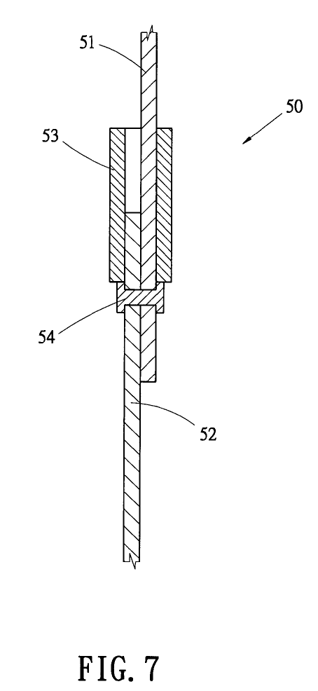

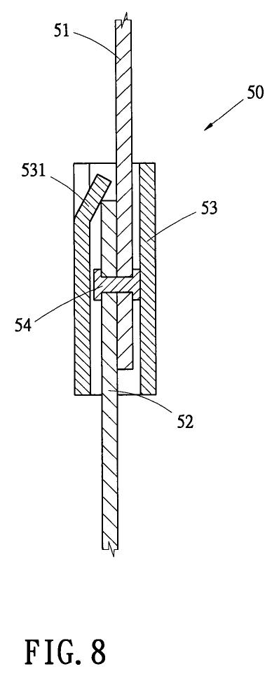

In addition to this, when the holder 53 is slipped over and firmly holds the mutual stacking area of the first and the second rod sections 51, 52, as shown in FIG. 7, a pivot 54 of the first and the second rod sections 51, 52 is abutted against directly by the holder 53 to prevent the holder 53 from slipping off. And as shown in FIG. 8, the holder 53 can be provided on one side of the top edge thereof near to the second rod section 52 with an engaging portion 531, when the holder 53 is tightly slipped over the mutual stacking area of the first and the second rod sections 51, 52, the engaging portion 531 abuts on an edge of the second rod section 52 to prevent it from loosening and slipping off.

By all means, the lampshade of the present invention can also has the upper and the lower annular rings 20, 30 designed as couples of semicircles able to be pivotally connected to form the annular rings, there are pivots provided between the semicircles for collapsing by folding the latter, thereby the annular rings can further be collapsed to reduce the area the entire lampshade occupies.

As stated above, the improved structure of foldable lampshade of the present invention has the improvement on the structure of the foldable connecting portion on the lampshade to assure firmness of the connecting portion in the form of a slipping-over member and the structure of the lampshade to avoid the danger of tilting of the lampshade. Thereby, the foldable lampshade gets a better practicable structure.

The description stated above and the drawings shown are only for illustrating preferred embodiments of the present invention, and not for giving any limitation to the scope of the present invention. It will be apparent to those skilled in this art that various modifications or changes in structure or means made to the present invention without departing from the spirit of this invention shall also fall within the scope of the appended claims. Having thus described the present invention, what we claim as new and desire to be secured by Letters Patent of the United States are:

1. An improved structure of foldable lampshade, said lampshade is comprised of a soft shading member, an upper and a lower annular ring connected with said soft shading member, a plurality of brackets provided between said upper and lower annular rings for bracing said shading member, and a connecting portion in the form of a slipping-over member connected with said upper annular ring; wherein said connecting portion is slipped over to connect with a lamp set, a plurality of foldable rods are provided between said connecting portion and said upper annular ring, each of said foldable rods is composed of a first rod section and a second rod section pivotally connected with each other and respectively fixed on said upper ring and said connecting portion, when said first and second rod sections are pulled straight or folded, said connecting portion is fixed by bracing or is folded too; said structure is characterized by: each of said foldable rods is provided on a first rod section thereof with a holder in the form of a slide sleeve for the purpose of firmly holding a mutual stacking portion of said first rod section and a second rod section when said first and second rod sections are pulled straight, said holder restrains said first and second rod sections from folding in a contrary direction to assure structural firmness of said connecting portion and said lampshade and to avoid the danger of tilting of said lampshade.

2. The improved structure of foldable lampshade as in claim 1, wherein said brackets each is in the form of a single rod; said upper and lower annular rings are provided on the peripheries thereof at positions in corresponding to those for connecting the ends of said brackets with recesses and holes, said brackets are further provided each on said ends thereof respectively with a butt portion and a hook portion able to engage respectively with said recesses and holes; thereby said upper and lower annular rings are firmly connected with said brackets by engagement of said butt portions and hook portions with said recesses and holes of said upper and lower annular rings respectively.

3. The improved structure of foldable lampshade as in claim 2, wherein each of said recesses has stop means respectively on the top edge and one of two lateral sides thereof, said top stop means restrain said butt portions of said brackets from sliding off said recesses.

4. The improved structure of foldable lampshade as in claim 3, wherein said stop means provided on said lateral sides of said recesses are provided respectively on the like one of every said two lateral sides.

5. The improved structure of foldable lampshade as in claim 1, wherein said lower annular ring is formed from two semicircles, a pivot joint is provided between said two semicircles.

6. The improved structure of foldable lampshade as in claim 1, wherein when said holder is slipped over and firmly holds said mutual stacking area of said first and second rod sections, a pivot of said first and second rod sections is abutted against directly by said holder to prevent said holder from slipping off.

7. The improved structure of foldable lampshade as in claim 1, wherein said holder is provided on one side of the top edge thereof near to said second rod section with an engaging portion, when said holder is tightly slipped over said mutual stacking area of said first and second rod sections, said engaging portion abuts on an edge of said second rod section to prevent it from loosening and slipping off.
